(19) United States
(12) Patent Application Publication
(10) Pub. No.: US 2004/0108477 A1
(43) Pub. Date: Jun. 10, 2004

(54) Liquid control valve

(76) Inventors: Wolfgang Stoecklein, Stuttgart (DE); Dietmar Schmieder, Markgroeningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/381,237

(22) PCT Filed: Jul. 6, 2002
(86) PCT No.: PCT/DE02/02486

(30) Foreign Application Priority Data
Jul. 25, 2001 (DE) 101 36 786.6

(51) Int. Cl. F16K 31/12; B05B 3/04

(52) U.S. Cl. 251/57; 239/102.2

(57) ABSTRACT

A valve (2) for controlling fluids is proposed, with an actuator unit (4), which in particular is piezoelectric, for actuating a valve member assembly (5) that has at least one first piston (8) and one second piston (9), between which a hydraulic chamber (11) is disposed. The valve member assembly (5) actuates a valve closing member (10), which cooperates with at least one valve seat (12). Disposed between the second piston (9) and the valve closing member (10) is an intermediate piston (17), which has a smaller diameter than the second piston (9). The end of the intermediate piston (17) oriented toward the valve closing member (10) and an end of the first piston (8) oriented toward the piezoelectric actuator unit (4) border on a system pressure region (14). A transition region between the second piston (9) and the intermediate piston (17) is disposed in a region (18) whose pressure is less than that of the system pressure region (14).

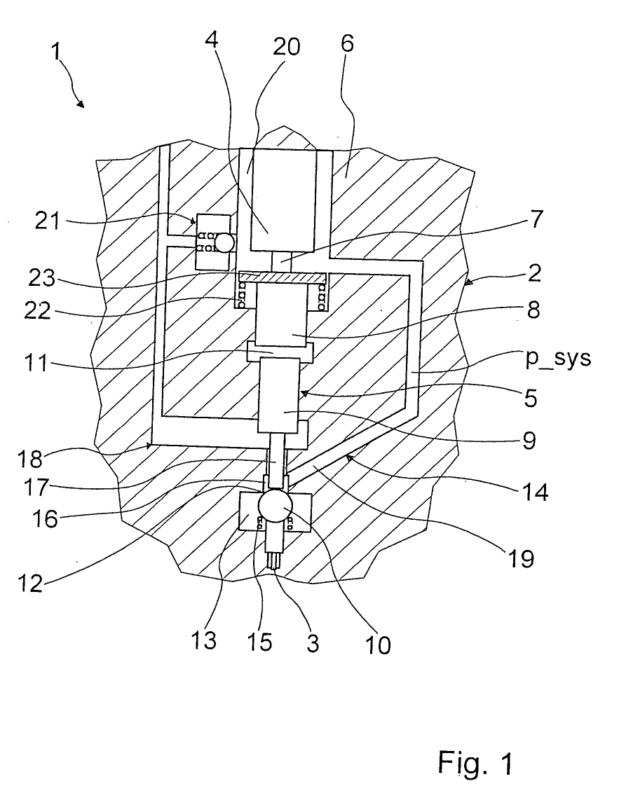

### PRIOR ART

The invention relates to a valve for controlling fluids having an actuator unit, in particular a piezoelectric actuator unit, for actuating a valve member assembly, as generically defined by the preamble to claim 1.

A valve for controlling fluids with a piezoelectric actuator unit for actuating a valve member is known from German Patent Disclosure DE 199 46 883 A1. In this valve, the valve member is disposed axially displaceably in a bore of a valve body and on one end has a valve closing member, which cooperates with at least one seat, provided on the valve body, for opening and closing the valve. The valve closing member disconnects a low-pressure region from a high-pressure region of the valve; the high-pressure region is for instance a rail pressure region in a common rail injection valve of a motor vehicle.

The valve member comprises a first and a second piston, between which a hydraulic chamber acting as a hydraulic booster is disposed, which the pistons together with the valve body define. Such hydraulic boosters are provided in common-rail injection valves to lengthen the adjustment path of a piezoelectric actuator unit and to compensate for changes in length caused by temperature differences.

Upon actuation of the two pistons by the piezoelectric actuator unit, the hydraulic booster or hydraulic coupler is acted upon by a high pressure or a high adjusting force, with the result that hydraulic fluid or fuel present in the hydraulic coupler emerges between the pistons and the valve body, and hence the volume of the hydraulic coupler decreases steadily.

For this reason, the hydraulic booster must be refilled between the individual events of triggering of the valve, in order to avoid imprecision in subsequent valve actuations.

This kind of refilling of a hydraulic coupler is described in DE 199 46 883 A1; a filling device is provided for withdrawing hydraulic fluid from a high-pressure region of the valve. The filling device is embodied with a conduit that has a throttle bore and that for refilling the hydraulic coupler discharges into a gap surrounding the first piston and/or the second piston and has a branch, via an overpressure valve, to a low-pressure valve chamber. The low-pressure valve chamber borders on a valve seat that is closable by the valve closing member. The valve embodiment with this kind of filling device is relatively complicated and expensive, however.

To avoid the above disadvantages, subsequent developments have turned to embodying the entire valve region, beginning at the hydraulic coupler and extending to the valve seat of the valve closing member, as the system pressure; refilling of the hydraulic coupler is done simultaneously with the opening of the valve closing member.

So that between individual injections adequate filling of the hydraulic coupler will be assured and variations in quantity between the various injectors of an engine of a motor vehicle will remain slight, the system pressure should be at least equally high at all the injectors. For an exact mode of operation of the valves, it is advantageous if system pressure prevails in the entire low-pressure region of the valves, and if neither leak fuel flows nor diversion volume flows of the hydraulic medium occur between the injections.

For filling the hydraulic coupler, the two pistons must be pulled apart counter to the system pressure applied to them, so that the hydraulic fluid flows into the coupler chamber and the hydraulic booster is filled.

In the concrete realization of the valve, for the sake of fast enough filling, the second piston can be prestressed with a slight initial tension by a spring, so that the system pressure engaging the second piston is overcome, and the second piston is always kept in contact with the valve closing member.

However, since it is known that a spring is required to prestress the piezoelectric actuator unit, this means that one additional spring of the valve has to be calibrated. Besides this calibration effort, the scarce installation space available is a problem, since a fast-, uniformly- and readily-reacting spring necessitates a correspondingly long structural length.

Moreover, it is difficult to achieve exactly metered multiple injections, since in multiple injections the spring-loaded second piston may vibrate sharply under some circumstances, resulting in correspondingly great variations in the quantity.

### ADVANTAGES Of THE INVENTION

The valve of the invention having the characteristics of the preamble to the claim, in which an intermediate piston for actuating the valve closing member is disposed in the region between the second piston and the valve closing member, which intermediate piston has a smaller diameter than the second piston, and in which an end of the intermediate piston toward the valve closing member and an end of the first piston toward the piezoelectric actuator unit border on a system pressure region, and a transition region between the second piston and the intermediate piston is disposed in a region with a pressure less than the pressure of the system pressure region, represents an optimization of the hydraulic coupler function of the hydraulic chamber in terms of refilling, and advantageously it is possible to dispense with a spring that in the prior art acts on the second piston.

The filling of the hydraulic chamber in the valve of the invention takes place only via the first piston from the system pressure region, since only the end of the first piston toward the piezoelectric actuator unit is disposed in the system pressure region, while conversely the end of the second piston associated with the valve closing member is disposed in the region with a lesser pressure than the system pressure. Thus as the hydraulic chamber becomes increasingly full, the second piston is displaced together with the intermediate piston in the direction of the valve closing member, where finally, once the hydraulic chamber has been optimally filled, the second piston comes to rest on the valve closing member, assuring injection without delay the next time the valve is triggered.

The displacement of the second piston in conjunction with the intermediate piston is advantageously assured by the provision that the intermediate piston is embodied with a smaller diameter than the second piston. The second piston is engaged by an adjusting force that is correspondingly greater, by the ratio in diameter between the second piston and the intermediate piston, than the force engaging the intermediate piston, so that the second piston is displaced in the direction of the valve closing member without additional spring force.

The intermediate piston, the diameter ratio between the second piston and the intermediate piston, and the disposition of the end faces of the second piston and of the intermediate piston in different pressure regions assure fast filling of the hydraulic coupler in a simple manner.

Further advantages and advantageous features of the subject of the invention can be learned from the description, drawing and claims.

### DRAWING

In the sole figure of the drawing, one exemplary embodiment of a valve for controlling fluids is shown, highly schematically, whose structure and mode of operation will be explained in further detail in the ensuing description.

The drawing shows a detail of a fuel injection valve with a trigger unit.

### DESCRIPTION OF THE EXEMPLARY EMBODIMENT

The drawing shows a detail, schematically highly simplified, of a fuel injection valve 1 for installation in an internal combustion engine, not otherwise shown, of a motor vehicle; in the present case, it is embodied as a common-rail injector for injection of preferably Diesel fuel.

The fuel injection valve 1 includes as its essential components a valve 2 for controlling fuel and a nozzle module, which is not otherwise shown and whose construction is known per se.

The nozzle module includes a valve control piston, which is guided in a nozzle body and is in operative connection with, or forms a structural unit together with, a nozzle needle that controls an opening of the fuel injection valve 1 leading to the combustion chamber of the engine. A so-called valve control chamber borders on the free face end of the valve control piston. By way of the pressure level prevailing in the valve control chamber, the position of the valve control piston or nozzle needle is adjusted. For that purpose, the valve control chamber communicates via a high-pressure supply line with a high-pressure reservoir, or so-called common rail, that is provided in common for a plurality of injection valves. The fuel carried in the high-pressure supply line can be at a pressure of over 1.8 kbar.

Moreover, the valve control chamber communicates via an outlet throttle with the valve 2 for controlling fuel, by way of which valve an injection onset, injection duration, and injection quantity can be adjusted.

For triggering, the valve 2 includes a piezoelectric actuator unit 4, which is disposed on the side of the fuel injection valve 1 remote from the combustion chamber of the engine and is used to actuate a valve member assembly 5. The piezoelectric actuator unit 4, or its piezoelectric ceramic, is constructed in a known manner from multiple layers and is braced by one end on a wall of a valve body 6. On its side toward the valve member assembly 5, the ceramic is operatively connected via an actuator head 7 with a first piston 8 of the valve member assembly 5; the piezoelectric actuator unit and the valve member assembly 5 are disposed in line with one another in the axial direction of the valve 2.

Besides the first piston 8, the valve member assembly 5 also has a further, second piston 9, which is also guided in the valve body 6. The first piston is also known as an adjusting piston or first booster piston, and the second piston 9 acts as the so-called actuating piston or second booster piston of the fuel injection valve 1; the second piston 9 serves to actuate a valve closing member 10. Between the pistons 8, 9, of which the first piston 8 has a larger diameter than the second piston 9, a hydraulic chamber 11 acting as a hydraulic booster is disposed, so that an axial deflection of the first piston 8 caused by imposition of voltage by the piezoelectric actuator unit 4 is transmitted via the hydraulic chamber 11 to the second piston 9, which executes a stroke that is increased by the boosting ratio of the piston diameters of the two pistons 8, 9.

The valve closing member 10 cooperates with a valve seat 12, which is embodied on the valve body 6 and is designed here as a ball seat for the valve closing member 10 shown in spherical form. The spherical form shown for the valve seat 12 and the valve closing member 10 is merely one preferable embodiment, since it is understood to be within the judgment of one skilled in the art to embody both functional parts in some other way, that is, with a different geometrical shape. It is furthermore conceivable for the valve closing member to cooperate optionally with two valve seats and then to be a so-called double seat valve.

When the piezoelectric actuator unit 4 is unactuated, or in other words is without voltage, the valve closing member 10 rests on the valve seat 12 and disconnects a high-pressure region 13 from a system pressure region 14 that borders on the valve seat 12. Operating pressures of 1.8 kbar, for instance, can prevail in the high-pressure region 13; these exceed system pressures of the system pressure region, which are generally in the range between 2 bar and 50 bar and preferably between 20 bar and 30 bar, multiple times. This pressure difference brings about secure closure of the valve seat 12 by the valve closing member 10 when the piezoelectric actuator unit 4 is not actuated.

To keep the valve closing member 10 in contact with the valve seat 12 even when there is a lack of a pressure difference and the piezoelectric actuator unit 4 is unactuated, a spring 15 is provided, which presses the valve closing member 10 against the valve seat 12.

A valve chamber 16 adjoining the valve seat 12 on the low-pressure side includes a pressure reservoir volume that has the system pressure p_sys, which amounts to approximately 30 bar. An intermediate piston 17 for actuating the valve closing member 10 is disposed in a region between the second piston 9 and the valve closing member 10. The intermediate piston 17 has a smaller diameter than the second piston 9; the end of the intermediate piston 17 toward the valve closing member 10 is disposed in the system pressure region 14, and an end toward the second piston 9 is disposed in a return region 18, whose pressure is less than the pressure of the system pressure region 14.

The intermediate piston 17 is guided in the valve body 6, and a guide 25 of the intermediate piston is embodied with a play such that a pressure difference between the system pressure region 14 and the return region 18 is preserved. This means that the guide 25 must be designed with a narrow guidance play, so that leakage losses from the system pressure region 14 in the direction of the return region 18 will be slight.

The system pressure region 14 extends from the valve chamber 16 via the line 19 as far as a further valve chamber 20, which is defined, on its side toward the valve member assembly 5, by the first piston 8. Also, essentially the system pressure p_sys prevails in the hydraulic chamber 11. The system pressure p_sys of the system pressure region 14 is defined by a pressure holding valve 21 that is in communication with the further valve chamber 20; impermissibly high pressures in the system pressure region 14 are diminished by a responding pressure holding valve 21 in the direction of the return region 18. In other words, if the system pressure is too high, the pressure holding valve 21 opens, and a defined quantity of fuel is carried out of the system pressure region 14 into the return region 18.

Refilling of the hydraulic chamber 11 that follows an injection event will now be described:

In the case of an unactuated piezoelectric actuator unit 4, the first piston 8 is pressed against the piezoelectric actuator unit 4 by a spring 22, which is braced on the valve body 6 and on a collar 23 of the first piston 8.

Because of the reduced volume of the hydraulic chamber 11 after an injection event, the second piston 9 is displaced axially so far in the direction of the first piston 8 that a gap is formed between the intermediate piston 17 and the valve closing member 10. Since this represents an unwanted position of the valve member assembly 5 if delay-free triggering of the fuel injection valve 1 is to be accomplished, the hydraulic chamber 11 must be filled in such a way that the intermediate piston 17 comes to rest on the valve closing member 10.

The filling of the hydraulic chamber 11 is done from the system pressure region 14 into the hydraulic chamber 11 in such a way that because of the system pressure p_sys, fuel from the further valve chamber 20 flows over the gap between the first piston 8 and the valve body 6 into the hydraulic chamber 11. Filling from the return region 18 via the guide gap between the second piston 9 and the valve body 6 does not occur, because the pressure in the return region, of approximately 1 bar, is so slight.

The intermediate piston 17 is embodied with a lesser diameter than the second piston 9, so that because of the piston diameter ratio between the intermediate piston 17 and the second piston 9, a displacement of the second piston 9 and of the intermediate piston 17 in the direction of the valve closing member 10 occurs.

The spring 15, which is disposed on the side of the valve closing member 10 remote from the intermediate piston 17 and is intended to keep the valve closing member 10 against the valve seat 12 even if the high pressure or rail pressure does not prevail in the high-pressure region 13, is dimensioned such that when the fuel injection valve is installed vertically in a cylinder head, it exerts the force of gravity of the valve closing member 10, intermediate piston 17, and second piston 9. The spring 15 can accordingly be made quite small, and the force to be exerted by the spring 15 can be in a range of less than 1 N.

In the present exemplary embodiment, the intermediate piston 17 is embodied as a separate component from the second piston 9; it is understood to be within the judgment of one skilled in the art to embody the second piston and the intermediate piston integrally, so that the second piston is thus embodied as a stepped piston, which with its region having a lesser cross section extends as far as the valve closing member.

1. A valve (2) for controlling fluids, having an actuator unit (4), which in particular is piezoelectric, for actuating a valve member assembly (5) that has at least one first piston (8) and one second piston (9), which are guided in a valve body (6) and between which a hydraulic chamber (11) acting as a hydraulic booster is disposed, and via the valve member assembly (5), a valve closing member (10) is actuated which cooperates with at least one valve seat (12) embodied on the valve body (6) and in its closing position divides a system pressure region (14) of the valve (2) from a high-pressure region (13), characterized in that the valve member assembly (5), in the region between the second piston (9) and the valve closing member (10), includes an intermediate piston (17), which has a smaller diameter than the second piston (9), and an end of the intermediate piston (17) oriented toward the valve closing member (10) and an end of the first piston (14) oriented toward the piezoelectric actuator unit (4) border on the system pressure region (14), and a transition region between the second piston (9) and the intermediate piston (17) is disposed in a region (18) having a pressure less than the pressure of the system pressure region (14).

2. The valve of claim 1, characterized in that the second piston (9) and the intermediate piston (17) are embodied integrally.

3. The valve of claim 1 or 2, characterized in that the second piston (9) and the intermediate piston (17) are embodied as separate components.

4. The valve of one of claims 1-3, characterized in that the system pressure (p_sys) of the system pressure region (14) is limited by a pressure holding valve (21).

5. The valve of one of claims 1-4, characterized in that the intermediate piston (17) is guided in the valve body (4).

6. The valve of claim 5, characterized in that the guide (25) of the intermediate piston (17) is embodied with a play such that a pressure difference between the system pressure region (14) and the region (18) having a pressure less than the system pressure (p_sys) is preserved.

7. The valve of one of claims 1-6, characterized in that the region having a pressure less than the system pressure (p_sys) acts as a return region (18).

8. The valve of one of claims 1-7, characterized by its use as a component of a fuel injection valve (1) for internal combustion engines, in particular of a common-rail injector.
